(19) United States
(12) Patent Application Publication
(10) Pub. No.: US 2003/0052465 A1
(43) Pub. Date: Mar. 20, 2003

(54) Cleaning apparatus

(76) Inventors: Tauqir Ahmed, Naperville, IL (US); Richard L. Raz, Carol Stream, IL (US)

Correspondence Address: MATHEW R. P. PERRONE, JR., 210 SOUTH MAIN STREET, ALGONGUIN, IL, 60102-2639, US

(21) Appl. No.: 09/955,692

(22) Filed: Sep. 19, 2001

(51) Int. Cl. A47L 13/50; B62B 1/00

(52) U.S. Cl. 280/79.5; 15/257.01

(57) ABSTRACT

A cleanup device includes a dolly and a waste container and tools, which provides for storage of the cleaning material therein and a releasable wheel lock to position the dolly, and hence the cleanup device, at a desired site.

This invention relates to a cleaning apparatus; and more particularly to a cleaning apparatus adapted to be moved to a desired position in order to contain or dispose of a spilled material.

### BACKGROUND OF THE INVENTION

Many materials are extremely dangerous to human beings. Yet, those materials are required to carry out the functions of modern life. Sometimes an accident or a mistake occurs, causing such a material to spill or be otherwise improperly positioned. Such a misfortunate occurrence can cause great danger to anyone in the neighborhood of this spill. It is, therefore, imperative that such a spill be cleaned up quickly, efficiently and safely.

The cleaning process requires that certain materials and tools being moved to the site and a safe and an efficient manner. There must also be an effective storage mechanism for the spilled material to be transported to an appropriate place for disposal.

Getting these materials and tools to the site can be cumbersome. Not only must a number of tools be transported, cleaning material must also be transported to the place of a spill. The material is sometimes heavy and difficult to transport. Tools can also be bulky, and equally hard to handle.

In order to compensate for the heavy material and the bulky tools, many carts or other transportation devices are known. These carts of the prior art have many defects. Many times, the cart does not move efficiently. Many times, the tools are not properly supported on the cart. With all the tools on the cart, it becomes difficult to have the appropriate cleaning material transported with the tools.

Additionally, the desired tools for cleanup purposes can be bulky in their own right. Such bulkiness makes those tools difficult to transport. For example, it is difficult to carry a broom, a shovel, and a dustpan at the same time. Combining this factor with the requirement to carry a heavy cleaning material to the site, while providing for temporary storage of the years cleaning material, many cleanup problems become apparent.

It follows that it is very desirable to develop a device which can carry appropriate cleaning material to a desired site along with the desired tools. It is furthermore useful to have that device support to cleaning material in the tools and efficient fashion.

Once the cart reaches the site, is very desirable to avoid an improperly positioned cart and keep the cart in a substantially fixed position. In this fashion, the cleanup procedure can be accomplished efficiently with the tools and materials at hand. However, the requirement for the cart to be both easily movable and fixed position are contradictory. Easily movable requirements are reduced or compromised by fixed position. Fixed position usually means not easily moved.

Even more advantageous is a storage compartment for moving a residue of the cleanup procedure to a safe disposal area. With the joint transportation of the required tools and cleaning material, removal of the used cleaning material creates a problem. No efficient way to maximize all of these advantages is known.

### SUMMARY OF THE INVENTION

Among the many objectives of this invention is the provision of a cleanup device having a transport dolly capable of supporting cleaning material, tools, and a temporary storage facility.

A further objective of this invention is to provide a cleanup device, which can be easily transported to a desired location.

A still further objective of this invention is to provide a cleanup device, which can be reasonably secured in a desired location.

Yet a further objective of this invention is to provide a cleanup device, which includes temporary storage for used cleaning material.

Also an objective of this invention is to provide a cleanup device, which supports a number of tools in a releasably secure fashion.

Another objective of this invention is to provide a cleanup device, which transports cleaning material to a desired site.

Yet another objective of this invention is to provide a cleanup device, which provides most necessary items for a cleanup project.

Still another objective of this invention is to provide a cleanup device, which transports used cleaning material to a desired disposal site.

A further objective of this invention is to provide a method for cleaning a spill.

A still further objective of this invention is to provide a method for transporting all necessary items for cleaning a still at the same time.

These and other objectives of the invention (which other objectives become clear by consideration of the specification, claims and drawings as a whole) are met by providing a cleanup device having a dolly to support a waste container and tools, while providing for storage of the cleaning material therein and a releasable wheel lock to position the dolly, and hence the cleanup device, at a desired site.

### BRIEF DESCRIPTION OF THE DRAWINGS

FIG. 1 depicts a perspective view of the universal cleanup device 100 of this invention.

FIG. 2 depicts a perspective view of the universal cleanup device 100 of this invention, based on FIG. 1, but rotated about 120 degrees.

FIG. 3 depicts a perspective view of the universal cleanup device 100 of this invention, based on FIG. 2, but rotated about 120 degrees.

FIG. 4 depicts a perspective view of the dolly 120 for the cleanup device 100 of this invention.

Throughout the figures of the drawings, where the same part appears in more than one figure of the drawings, the same number is applied thereto.

### DESCRIPTION OF THE PREFERRED EMBODIMENTS

For cleaning a spill or another undesirable, removable surface coating; a cleanup device has a light weight dolly with a drum or container mounted thereon. The dolly and the container or cooperate to support all necessary tools and materials required for the cleanup. The dolly renders the container and the tools very portable. The dolly and the container cooperate to the support most of the tools required for the cleanup.

Almost any type of tool may be supported on the cleanup device. Such tools are exemplified by, but not limited to, a shovel, a broom, a dustpan, a utility bag, and a lid holder.

The dolly is supported on a set of wheels or casters. These casters are sufficiently strong to support the cleanup device while maintaining mobility of the cleanup device. Within the dolly is a side opening and a top opening. The side opening provides access to a compartment on the interior of the dolly and permits a cleanup material to be stored therein. The side opening also permits removal of and use of the cleanup material therefrom at the site of the spill. The top opening can permit adding of the cleanup material to the dolly.

The dolly has preferably a generally polygonal shape. A bridge or a shelf on at least one side of the dolly may provide a tool support. If support for more than one tool is desired, a bridge or a shelf may be adapted for use with each desired tool.

On another side in an opening adapted to provide access to the compartment therein. Within the compartment, may be stored cleaning material. Typical cleaning materials are the powder commonly known as oil dry and the like. On another side is a tool shelf. In fact, a plurality of tools shelves may be on the sides of the dolly.

Within the top of the dolly is an indentation adapted to receive a drum. Into the drum may be placed the used cleaning material. Also, on the drum are a number of gripping devices adapted to cooperate with a plurality of tools and hold each in a desired position. Such a gripping device may be an integral device attached directly to the drum. A skirt may also be draped over the drum, with at least one mounted gripping device attached to the skirt in order to support at least one desired tool. Preferably most, if not all of the gripping devices are mounted on the skirt. Also, secured to the drum or to the skirt may be at least one utility bag for a plurality of any desired smaller items.

In a preferred form, the drum has a lid. The lid provides for covering the drum when the residue of the cleanup is placed therein. When the preferred lid is present, a drum strap may hold the lid adjacent to the drum, when removal thereof is desired. In this fashion, the lid can be easily placed on the drum again, or removed, while being maintained in a controlled fashion near the drum and the cleanup dolly.

In order to keep the cleanup material within the interior of the dolly, a flexible closure is placed thereover. Preferably, the closure is secured at a bottom portion of the opening. A releasable holding mechanism secures a top of the flexible closure to the dolly. With the flexible closure secured over the opening, inadvertent release of the cleanup material from the interior of the dolly is greatly reduced.

In a preferred form, the dolly is preferably manufactured from a light weight polyethylene plastic. In this fashion, an easily transported dolly is provided. This cleanup device provides for the easy movement and quick response time, to emergency clean-ups (spills). It features an opening, designated for the dispensing of the floor absorbents or oil absorbing material. Up to 100 kilograms of absorbent for spill clean-ups, can easily be transported to a desired site and shoveled out from this opening.

There can be a fabricated cloth to cover the side opening when moving the dolly, so the absorbent material does not spill out. There will also be an opening on the top of the dolly, which permits the floor absorbent floor absorbent to be put into the dolly. This opening in the top of the dolly is covered by the utility drum.

It follows that this cleanup device also features a utility drum and lid mounted on the dolly. The drum will be able to releasably lock or fit into place on the dolly base. This dolly will be easily maneuverable on preferably four casters. Two of the casters, preferably on the back opposite the opening, are lockable. This will be a benefit when shoveling out the absorbent or other cleaning material at a clean up site. The dolly will stay in place and not move.

Around the drum may be the fabricated skirt, which will be able to hold a shovel, broom, dustpan or other desired items or tools. These items are supported at one end by a holding device, which may cooperate with a shelf on the dolly to support each item. The holding device may be a loop or clamp mounted on the skirt, or by a loop or clamp preferably mounted on the drum. In some cases, a larger tool, such as a broom or a shovel, is also supported by a ledge on the dolly.

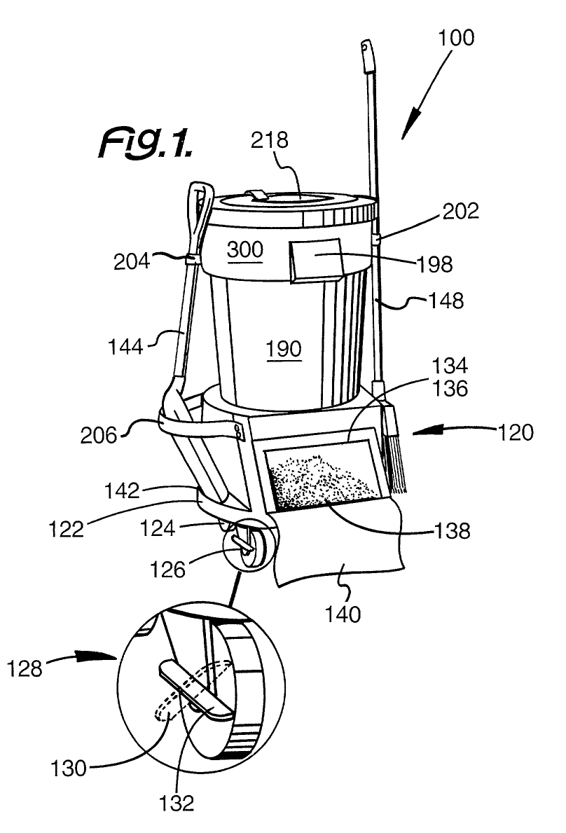

Referring now to FIG. 1, the cleanup device 100 has a movable dolly 120 with a drum 190 thereon. The dolly 120 has a base 122, on which are mounted two free casters 124 and two lockable casters 126. Each of the lockable casters 126 has a locking device 128, which can prevent lockable casters 126 from rolling when locking device 128 is in locked position 132. When locking device 128 is moved to an unlocked position 130, lockable casters 124 are free to move and thus combine with free casters 122 and permit cleanup device 100 to be moved as desired.

Within the cleanup dolly 120 is an open side 134. Open side 134 contains access opening 136. From access opening 136, is possible to retrieve cleaning material 138 and apply it to a spill (not shown). Access opening 136 is closable with a flap door 140, secured thereover in a standard fashion. Flap door 140, when closed, prevents spilling of cleaning material 138 during movement of the clean up device 100.

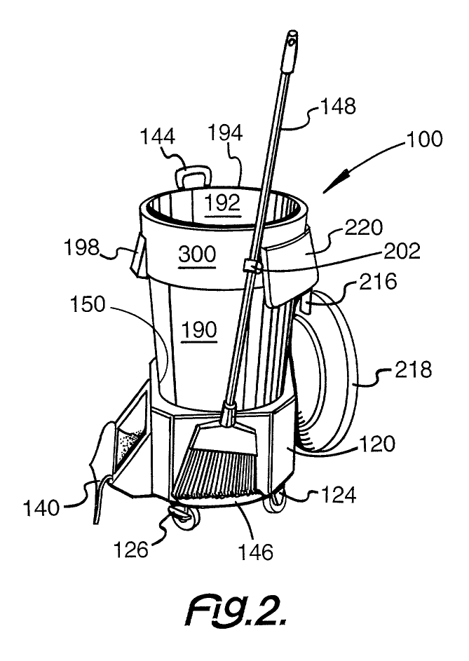

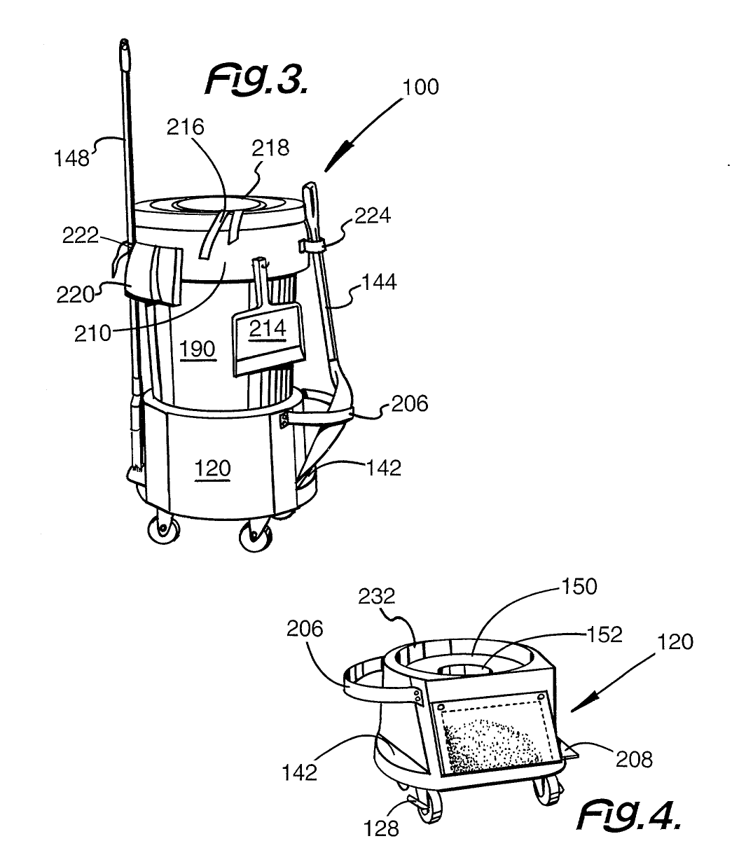

Adding FIG. 2 and FIG. 3 to the consideration, on another side of cleanup dolly 120 is shovel ledge 142, which receives one end of shovel 144. On still another side of cleanup dolly 120 is broom ledge 146, adapted for supporting one end of broom 148. Broom ledge 146 and shovel ledge 142 (FIG. 1) on dolly 120 provide resting places for one end of broom 148 and shovel 144 to be supported by dolly 120.

Considering additionally FIG. 4, in a top portion of cleanup dolly 120 is a drum recess 150. The drum recess 150 includes therein a filling aperture 152. Through the filling aperture 152 a desired cleaning material may be inserted.

Referring again to FIG. 2, oppositely disposed drum handles 198 serve as gripping points for drum 190, in order to move drum 190 onto or off of dolly 120. Drum recess 150 on dolly 120 may receive drum 190. Drum 190 serves as a temporary receptacle for used cleaning material, and provides support for other tools. Within drum 190 may be placed a flexible and disposable bag 192. Bag 192 protects and extends the useful life of drum 190. Bag 192 is sufficiently large to drape over the top edge 194 of drum 190.

Drum 190 may include a broom support 202, which cooperates with broom ledge 146 and supports broom 148 on cleaning device 100. In a like fashion, drum 190 may also include an upper shovel support 204. The upper shovel support 204, cooperates with a lower shovel support 206 mounted on the dolly 120, both of which cooperate with shovel ledge 142 and help to carry shovel 144 to a desired cleanup spot.

Both upper shovel support 204 and lower shovel support 206 may be formed of rigid or flexible straps of sufficient size to support the shovel 144 on the cleaning device 100. Likewise, either or both may be permanently or releasably secured to the cleaning device 100. The releasable securing device or fastener may be at least one selected from a snap assembly, a pinned assembly, a hook and loop assembly, or the like. The permanent securing device may be rivets, nuts and bolts, glue, or the like.

Referring again to FIG. 3, in a preferred fashion, drum 190 has a mounting cloth 210 draped over the edge thereof. On mounting cloth 210 is secured a hook 212 adapted to receive a dustpan 214. Also on mounting cloth 210 or drum 190 may be mounted a lid strap 216. Lid strap 216 supports a lid 218 capable of closing drum 190. In a like fashion, mounting cloth 210 may include a utility bag 220 for holding any other desired cleaning element.

Also preferred is to eliminate broom support 202 (FIG. 2), upper shovel support 204 and lower shovel support 206 from drum 190; and provide devices having a similar function on the skirt 210 (FIG. 3). Skirt 210 drapes over top edge 194 of drum 190, either over or under bag 192. On skirt 210 are preferably positioned broom fastener 222 to replace broom support 202, upper shovel fastener 224 to replace upper shovel support 204.

Broom fastener 222, broom support 202, upper shovel fastener 224, upper shovel support 204, lower shovel fastener 226 and lower shovel support 206 may be formed in any suitable fashion. Typical items suitable for use thereas include; but are not limited to; spring clips, hooks, and a hook and loop assembly strap (commonly available under the Registered Trademark VELCRO.

Adding FIG. 4 to the consideration, drum recess 150 provides a drum cradle 232. Into drum cradle 232, drum 190 may be placed, thereby covering filling aperture 152. This combination of structure provides for moving of drum 190 on dolly 120 to a desired position, cleaning up whatever spill is there, putting the material into the flexible bag 192 contained within the drum 190 and transporting the material to a desired disposal area.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after, and only after, that person has made a careful study of this disclosure.

Because of this disclosure and solely because of this disclosure, modification of this method and apparatus can become clear to a person having ordinary skill in this particular art. Such modifications are clearly covered by this disclosure.

What is claimed and sought to be protected by Letters Patent of the United States is:

1. A cleanup device adapted to transport desired material and at least one tool to a desired position comprising:
(a) the cleanup device including a dolly and a waste container;
(b) the dolly being adapted to support at least one tool;
(c) the dolly being movable to or from the desired position;
(d) the dolly being releasably securable at the desired position; and
(e) the waste container being removably secured to the dolly.

2. The cleanup device of claim 1 further comprising:
(a) the dolly being supported on a set of casters;
(b) the set of casters supporting the cleanup device;
(c) the set of casters providing mobility to the cleanup device;
(d) the dolly including an interior compartment supported on a set of casters; and
(e) the interior compartment being adapted to receive a cleaning material.

3. The cleanup device of claim 2 further comprising:
(a) the dolly having a side opening and a top opening;
(b) the side opening serving to permit removal of the cleaning material therefrom at the desired position;
(c) the top opening serving to permit addition of the cleaning material to the dolly; and
(d) the dolly having a generally polygonal shape.

4. The cleanup device of claim 3 further comprising:
(a) the dolly having at least one shelf on the at least one side of the dolly may provide a tool support;
(b) the at least one shelf being adapted to support a tool to be carried to the desired position;
(c) an indentation adapted to receive a drum being adjacent to the top opening; and
(d) the top opening being closable by the drum in the indentation.

5. The cleanup device of claim 4 further comprising:
(a) at least one mounted gripping device being on the drum; and
(b) the at least one shelf cooperating with the at least one mounted gripping device in order to support a tool on the cleanup device.

6. The cleanup device of claim 4 further comprising:
(a) a skirt being mounted on the drum;
(b) at least one mounted gripping device being on the skirt; and
(c) the at least one shelf cooperating with the at least one mounted gripping device in order to support a tool on the cleanup device.

7. The cleanup device of claim 4 further comprising:
(a) a lid being adapted to cover the drum; and
(b) a fastening device attaching the lid to drum.

8. The cleanup device of claim 4 further comprising:
(a) a flexible closure being adapted to cover the side opening;
(b) the flexible closure being secured to an edge of the side opening; and
(c) the flexible closure serving to contain the cleaning material within the dolly, while providing access thereto.

9. The cleanup device of claim 4 further comprising:
(a) the set of casters including a pair of lockable casters and a pair of free casters;
(b) the pair of lockable casters having locked position and an unlocked position; and
(c) the locked position serving to releasably fix the position of the cleanup device.

10. The cleanup device of claim 9 further comprising:
(a) the pair of lockable casters being oppositely disposed from the side opening;
(b) the skirt including at least one fastener; and
(c) the at least one fastener cooperating with the shelf in order to hold a desired item.

11. The cleanup device of claim 10 further comprising:
(a) the at least one fastener being at least one selected from a snap assembly, a pinned assembly, a hook and loop assembly, a rivet assembly, a nut and bolt assembly, and glue; and
(b) a lid strap being adapted to secure the lid to the drum.

12. The cleanup device of claim 10 further comprising:
(a) the drum having a disposable bag mounted therein; and
(b) the cleanup device being adapted to receive at least one tool selected from the group consisting of a broom, a dustpan, a utility bag, and the lid strap.

13. A cleanup device adapted to transport desired material and at least one tool to a desired position comprising:
(a) the cleanup device including a dolly and a waste container;
(b) the dolly being adapted to support at least one tool;
(c) the dolly being movable to or from the desired position;
(d) the dolly being releasably securable at the desired position;
(e) the waste container being removably secured to the dolly;
(f) the dolly being supported on a set of casters;
(g) the set of casters supporting the cleanup device;
(h) the set of casters providing mobility to the cleanup device;
(i) the set of casters including a pair of lockable casters and a pair of free casters;
(j) the pair of lockable casters having locked position and an unlocked position; and
(k) the locked position serving to releasably fix the position of the cleanup device.

14. The cleanup device of claim 13 further comprising:
(h) the dolly including an interior compartment;
(a) the dolly having a side opening and a top opening;
(b) the side opening serving to permit removal of the cleaning material therefrom at the desired position;
(c) the top opening serving to permit addition of the cleaning material to the dolly; and
(d) the dolly having a generally polygonal shape.

15. The cleanup device of claim 14 further comprising:
(a) the dolly having at least one shelf on the at least one side of the dolly may provide a tool support;
(b) the at least one shelf being adapted to support a tool to be carried to the desired position;
(c) an indentation adapted to receive a drum being adjacent to the top opening; and
(d) the top opening being closable by the drum in the indentation.

16. The cleanup device of claim 15 further comprising:
(a) a skirt being mounted on the drum;
(b) at least one mounted gripping device being on the skirt; and
(c) the at least one shelf cooperating with the at least one mounted gripping device in order to support a tool on the cleanup device.

17. The cleanup device of claim 16 further comprising:
(a) a lid being adapted to cover the drum;
(b) a fastening device attaching the lid to drum;
(c) a flexible closure being adapted to cover the side opening;
(d) the flexible closure being secured to an edge of the side opening; and
(e) the flexible closure serving to contain the cleaning material within the dolly, while providing access thereto.

18. The cleanup device of claim 17 further comprising:
(a) the pair of lockable casters being oppositely disposed from the side opening;
(b) the skirt including at least one fastener; and
(c) the at least one fastener cooperating with the shelf in order to hold a desired item.

19. A method for cleaning or removing an undesired, removable surface coating comprising:
(a) locating the undesired removable surface coating;
(b) moving a cleanup device to the end desired removable surface coating;
(c) locking the cleanup device into a desired position;
(d) determining an appropriate cleanup method;
(e) retrieving appropriate tools or material for cleanup from the cleanup device;
(f) removing undesired removable surface coating in the form of removed material;
(g) storing the removed material on the cleanup device;
(h) unlocking the cleanup device;
(i) moving at device to the desired area;
(j) disposing of the removed material and a proper fashion; and
(k) preparing the cleanup device for an additional use.

20. The method of claim 19 further comprising providing a dolly for the cleanup device:
(a) the dolly including an interior compartment;
(b) the dolly having a side opening and a top opening;
(c) the side opening serving to permit removal of the cleaning material therefrom at the desired position;
(d) the top opening serving to permit addition of the cleaning material to the dolly;
(e) the dolly having a generally polygonal shape.
(f) the dolly having at least one shelf on the at least one side of the dolly may provide a tool support;
(g) the at least one shelf being adapted to support a tool to be carried to the desired position;
(h) an indentation adapted to receive a drum being adjacent to the top opening; and
(i) the top opening being closable by the drum in the indentation.
